(19) United States
(12) Patent Application Publication
(10) Pub. No.: US 2004/0059781 A1
(43) Pub. Date: Mar. 25, 2004

(54) Dynamic presence indicators

(75) Inventors: John H. Yoakum, Cary, NC (US); Steve J. McKinnon, Cary, NC (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/247,591

(22) Filed: Sep. 19, 2002

(51) Int. Cl. G06F 15/16

(52) U.S. Cl. 709/204; 709/206

(57) ABSTRACT

The present invention provides a presence system capable of efficiently controlling the delivery of presence information for select individuals to a subscriber. Even if the subscriber has numerous individuals identified in a contacts list, only presence information for those individuals in an active list is provided to the subscriber. The active list can be relatively static or configured to change based on time and date, monitored events, availability of the subscriber, or other predefined criteria. The user can readily add or remove individuals from the active list in addition to selecting an inactive individual to monitor on an instantaneous basis, for a select period of time, until a successful communication occurs between the subscriber and selected individual, or until monitoring is no longer desired. The user can also issue one-time queries of typical or more detailed presence information about specific individuals.

### FIELD OF THE INVENTION

The present invention relates to providing presence information, and in particular to dynamically controlling the status of those whose presence is being tracked and indicators associated therewith.

### BACKGROUND OF THE INVENTION

Presence detection systems keep track of the apparent availability of individuals by monitoring their relative interaction with various communication devices, and perhaps their location. A presence system will determine the individual's availability, and provide the availability information to a user who subscribes to a presence service. Typically, the user subscribes to receive presence information pertaining to the availability of multiple individuals. As the monitored individuals go through their daily business, their availability will change from time to time. Changes in availability typically result in a notification being provided to the subscribing user. In certain configurations, the subscribing user will have an icon associated with each individual, wherein the icons will change as the availability of the corresponding individual changes.

Presence systems are preferably configured to easily add individuals to the list of individuals being monitored. The list of individuals being monitored is often referred to as a buddy list. As this technology becomes pervasive, and in combination with the ease of adding people to buddy lists, it is highly probable that these buddy lists will quickly become significantly large. As the number of individuals on the buddy list for a user increases, the number of availability changes provided to the user increases. At some point, the constant changes in availability of individuals being monitored by the user will become overly disruptive to the user of the buddy list, provide increased processing and traffic loads on the networks and devices supporting the presence system, and ultimately detract from the benefit of the technology.

Accordingly, there is a need for a simple and effective technique to maintain buddy lists, which are highly reflective of the actual set of individuals that the subscribing user would like to monitor or contact at any given time. There is a further need to dynamically change the buddy list as necessary and temporarily select an individual not on the buddy list to monitor in a dynamic fashion.

### SUMMARY OF THE INVENTION

The present invention provides a presence system capable of efficiently controlling the delivery of presence information for select individuals to a subscriber. Even if the subscriber has numerous individuals identified in a contacts list, only presence information for those individuals in an active list is provided to the subscriber. The active list can be relatively static or configured to change based on time and date, monitored events, availability of the subscriber, or other predefined criteria. The user can readily add or remove individuals from the active list in addition to selecting an inactive individual to monitor on an instantaneous basis, for a select period of time, until a successful communication occurs between the subscriber and selected individual, or until monitoring is no longer desired.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment constructed according to one embodiment of the present invention.

FIG. 2 is a logical representation of a presence system according to one embodiment of the present invention.

FIG. 3 is a flow diagram outlining a provisioning process according to one embodiment of the present invention.

FIG. 4 is a flow diagram outlining overall operation of a presence system according to one embodiment of the present invention.

FIG. 5 is a flow diagram outlining the processing of state information according to one embodiment of the present invention.

FIG. 6 is a communication flow outlining an exemplary process for automatically providing state information from a telephony system.

FIG. 7 is a block representation of a telephony switch constructed according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a presence system capable of efficiently controlling the delivery of presence information for select individuals to a subscriber. Even if the subscriber has numerous individuals identified in a contacts list, only presence information for those individuals in an active list is provided to the subscriber. The active list can be relatively static or configured to change based on time and date, monitored events, availability of the subscriber, or other predefined criteria. The user can readily add or remove individuals from the active list in addition to selecting an inactive individual to monitor on an instantaneous basis, for a select period of time, until a successful communication occurs between the subscriber and selected individual, or until monitoring is no longer desired.

In one embodiment, the centralized presence system keeps track of those individuals in the contact list as well as the active list, wherein only presence information for individuals in the subscriber's active list or specially selected for monitoring is delivered to a presence application running on a subscriber's hardware device. Alternatively, the presence application on the subscriber's hardware device keeps track of all contacts, including the active list, and subscribes to the service provided by the presence system to receive presence information for those on the active list and those specially selected for monitoring. The latter embodiment helps reduce network load and degree of processing required by the presence system.

The presence information for the various individuals on the active list may be determined by monitoring state information derived from a plurality of sources, which are associated with the individuals. Preferably, the sources of state information are devices, which are frequently used by an individual throughout a normal day and configured to provide state information to the presence system. The sources monitor normal user interactions and automatically provide corresponding state information to the presence system without requiring the user to enter or otherwise provide information bearing on their status or availability. The presence system will evaluate the state information from one or more sources to create presence information to deliver to subscribers. The state information bears on the presence or availability of the user and may take many forms. The presence information may range from complex analysis of state information from many devices to simply the states of selected devices. The following outlines numerous sources of state information along with the provisioning and operation of a presence system according to select embodiments of the present invention.

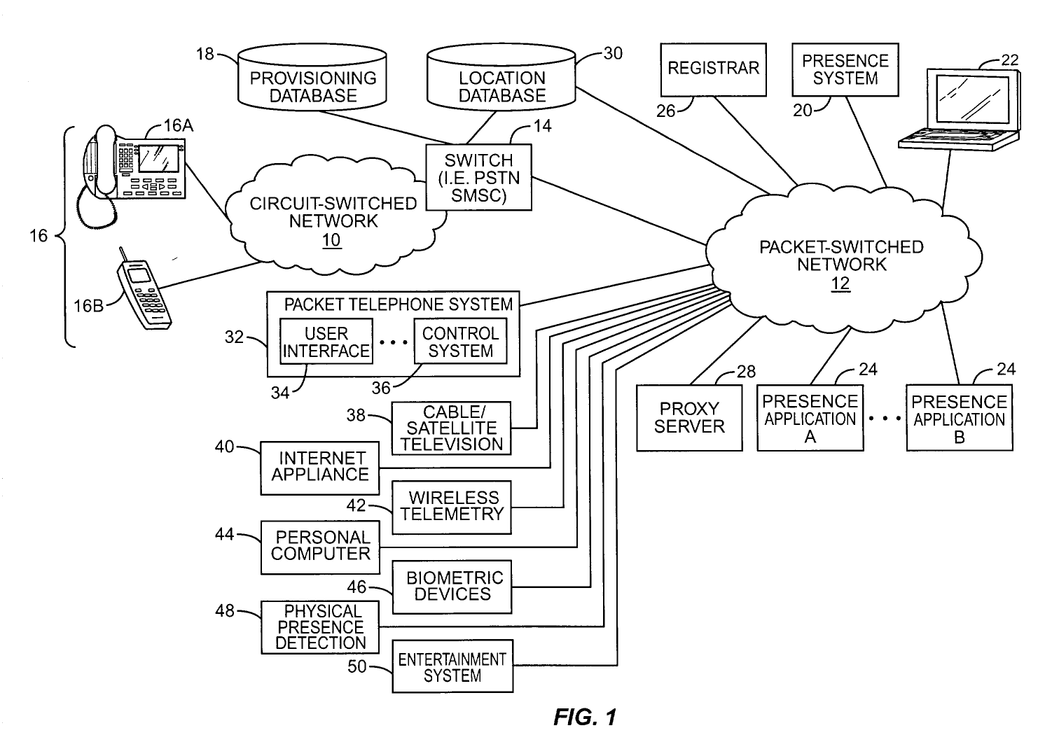

With reference to FIG. 1, a communication environment that is capable of automatically generating presence information from a plurality of sources is illustrated. Each individual whose presence is being monitored may be associated with multiple sources. In general, the more sources associated with each individual, the more accurate and complete the presence information for the individual will be. The communication environment may include a circuit-switched network 10, such as the public switched telephone network (PSTN) or a cellular communication network, and a packet-switched network 12, such as the Internet, which supports packet-switched communications. The circuit-switched network 10 may include various types of switches 14 to facilitate circuit-switched communications for landline or wireless communications. The circuit-switched network 10 supports communications with various types of telephony devices 16, such as a traditional landline telephone 16A or a mobile telephone 16B. In a wireless communication embodiment, the switches 14 cooperate with base stations (not shown), which facilitate wireless communications with mobile terminals, such as the mobile telephone 16B. Those skilled in the art will recognize the functionality of the switches 14 and other components in the circuit-switched network 10 to facilitate communications with the landline and wireless telephony devices 16.

The switch 14 is defined as being either an integrated device or multi-component system facilitating circuit-switched communication and including call server or call control functionality, which is traditionally provided in intelligent networks (IN), such as those implementing SS7 and the like. Typically, the switches 14 cooperate with a provisioning database 18, which provides information allowing a switch 14 to properly identify, locate, and provision the various telephony devices 16 in the circuit-switched network 10.

As noted, the present invention is particularly beneficial for automatically delivering state information, which is derived from natural user interaction with any number of sources, to a presence system 20 located on the packet-switched network 12. For example, the switch 14 may be configured to provide the state of the telephony device 16, its location, or a combination thereof, directly or indirectly to the presence system 20.

The presence system 20 may be configured by a subscriber device, such as a PC 22, and operates to collect state information for various devices of various individuals, process the state information to derive presence information, and provide the presence information to presence applications 24, automatically or in response to a request. Each presence application 24 is associated with a subscriber device (not shown), and provides alerts to the associated subscriber based on presence information associated with monitored individuals and derived from the presence system 20. Preferably, the presence application 24 subscribes to the presence system 20 and identifies the individuals whose presence information is desired. The presence system 20 will accept these subscriptions as well as register participating subscribers and individuals and their associated devices. The presence system 20 may also implement various presence delivery rules to allow individuals to control the dissemination of their presence information to the subscribers. Notably, various profiles may be established to allow select groups of subscribers to obtain more presence information than other groups. Accordingly, each registered individual may implement filters or rules to control dissemination of their information to subscribers. In the converse, those subscribing to receive presence information of certain individuals may also establish profiles identifying the individuals whose presence information is desired and the types of presence information they wish to receive.

A registrar 26 may be provided on the packet-switched network 12 to maintain a relationship between the logical and the physical addresses of devices that directly or indirectly communicate with the presence system 20. Such registration is typically required only when there is a change between the logical or user addresses and the physical addresses of a given device.

In one embodiment, the switch 14 is configured to provide state information corresponding to the status, mode, state, location, or a combination thereof associated with a telephony device 16 to the presence system 20. In this embodiment, it is preferable to provide a proxy server 28 to act as a liaison between the switch 14 and the presence system 20. As such, the switch 14 will provide presence information to the proxy server 28, which will represent the switch 14 to the presence system 20 in traditional proxy fashion. Those skilled in the art will recognize that the proxy server 28 is optional and may prove beneficial with certain communication protocols.

The state information provided to the presence system 20 from the switch 14 will depend on the application and the type of communication environment. For example, the traditional landline telephone 16A will not change location, typically providing location information only as a part of registration, and dynamically provide a mechanism to determine state information relating to its operation. For example, the switch 14 that serves the telephone 16A can determine whether the phone is on-hook or off-hook, and thus determine whether the user is engaged in a telephone call. More sophisticated systems may be able to determine whether the party is on a conference call, on hold, and whether any settings on the phone indicate that the user is in or out of the office. Accordingly, the state information gathered by the switch 14 in association with the operation of telephone 16A is used to create presence information to send to the presence system 20 via the proxy server 28.

For mobile terminals, such as the mobile telephone 16B, the servicing mobility switching center (SMSC), which is represented by switch 14, may gather all of the state information described above, as well as provide dynamic location information derived directly from the mobile terminal 16B or from the circuit-switched network 10. Accordingly, the state information for mobile devices may be supplemented with location information, which provides the presence system 20 the opportunity to distribute presence information to the various presence applications 24 based on dynamic location, if so desired. The location information may be provided by the mobile terminal 16B, if equipped with location detection technology, such as that provided by the Global Positioning System (GPS), wherein the mobile terminal 16B receives the GPS coordinates and may provide either the coordinates to the switch 14, which will determine the mobile terminal's location, or may process the GPS information to determine a location, which is then sent to the switch 14. Alternatively, triangulation techniques may be used to determine the mobile terminal's location, which may be stored in a location database 30 or like device. The location database 30 may be accessed via the switch 14 to obtain location information, or the location database 30 may be configured such that the presence system 20 or an associated device may directly access it via the packet-switched network 12.

Packet-based telephony devices, such as a packet telephone system 32, essentially emulate the operation of circuit-switched telephony devices 16 entirely over the packet-switched network 12. Thus, state information associated with a fixed or mobile packet telephone system 32 may be configured to automatically provide state information, and perhaps location information, to the presence system 20 directly or indirectly via the proxy server 28. The packet telephone system 32 will include a user interface 34 and a control system 36. As those skilled in the art will recognize, the packet telephone system 32 may be integrated into a single device, or may be implemented in multiple devices in a client-server configuration. For the latter case, the proxy server 28 may be further configured to support various operational features of the packet telephone system 32.

The user interface 34 may include a microphone and speaker to facilitate voice communications, as well as various keypads and displays to allow user interaction in traditional fashion. The control system 36 will operate to support the user interface 34 and provide the requisite functionality to enable the packet telephone system 32 to facilitate communications with other devices on the packet-switched network 12 directly or indirectly via the proxy server 28. For the purposes of description, assume that the control system 36 is capable of gathering and providing state information for the packet telephone system 32. In wireless environments, a wireless packet-switched network (not shown) is necessary to facilitate communications with the packet-switched network 12.

In addition to the telephony-based updates, an unlimited number of devices or systems with which users directly or indirectly interact may be modified to automatically provide state information. The devices and systems may include cable or satellite television systems 38, internet appliances 40, wireless telemetry devices 42, PCs 44, biometric devices 46, physical presence detections systems 48, entertainment systems 50, and the like. For example, set-top boxes or receivers of cable or satellite systems 38 may be configured to provide state updates to a central location, which forwards the updates to the presence service 20 in association with the user. These devices are normally on disparate networks and configured to communicate various types of information, such as billing information, to a central location. Preferably, a server at the central location will facilitate delivery of state information to the presence system 20. The server may be configured to monitor the respective devices to determine state changes, or may simply receive state changes generated by the devices. With the proliferation of broadband Internet connectivity, particularly in cable networks, devices of this type could also be directly attached to the packet-switched network 12 and provide state updates directly to the presence system 20. Similarly, internet appliances 40, such as refrigerators, dishwashers, alarm systems, and the like, can readily be configured to send state information relating to user interaction directly or indirectly to the presence system 20.

Wireless telemetry devices 42 may monitor an individual's interaction or location associated with a person or vehicle and provide state information to the presence system 20. Similarly, biometric devices 46, which monitor or check biometric data of the individual, and physical presence detection systems 48, which monitor physical presence, may provide state information to the presence system 20. Entertainment systems 50, such as home theater systems, gaming consoles, televisions, and the like can sense user activity and provide state updates to the presence system 20 for the associated individual. Any of the devices and systems may be connected directly or indirectly, via a gateway or the like, to the Internet.

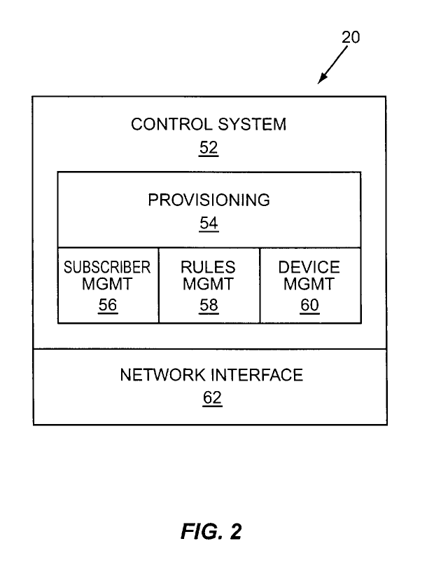

The presence system 20 may be implemented in one or more systems. With reference to FIG. 2, a logical breakdown of one embodiment of the presence system 20 is illustrated. The presence system 20 includes a control system 52 adapted to implement provisioning logic 54, subscriber management logic 56, rules management logic 58, and device management logic 60. The device management logic 60 facilitates and controls interaction with the various devices, which are configured to provide state information for an individual to the presence service 20 based on user interaction. The subscriber management logic 56 facilitates and controls interaction with the presence applications 24 associated with subscribers.

Accordingly, the presence applications 24 will subscribe to the presence service 20 to receive status updates for one or more individuals via the subscriber management logic 56. Based on the subscription, the presence service 20 will receive state information from the various devices associated with a number of individuals, evaluate the state information to generate presence information using rules in the rules management logic 58, and deliver the presence information to the corresponding presence applications 24 registered to receive presence information for the selected individuals. The device management logic 60 will control interaction with the various devices providing state information. Such control may include configuring the device to provide the state information in a specified manner and format. The provisioning logic 54 facilitates provisioning of the subscriber management logic 56, rules management logic 58, and device management logic 60. Provisioning may include establishing profiles for the individuals providing presence information. The profile will typically identify devices and their respective states to monitor, provide rules for evaluating the state information to generate the presence information, and identify subscribers, systems, or applications authorized to receive the information. The control system 52 is also associated with a network interface 62 for facilitating communications over the packet-switched network 12.

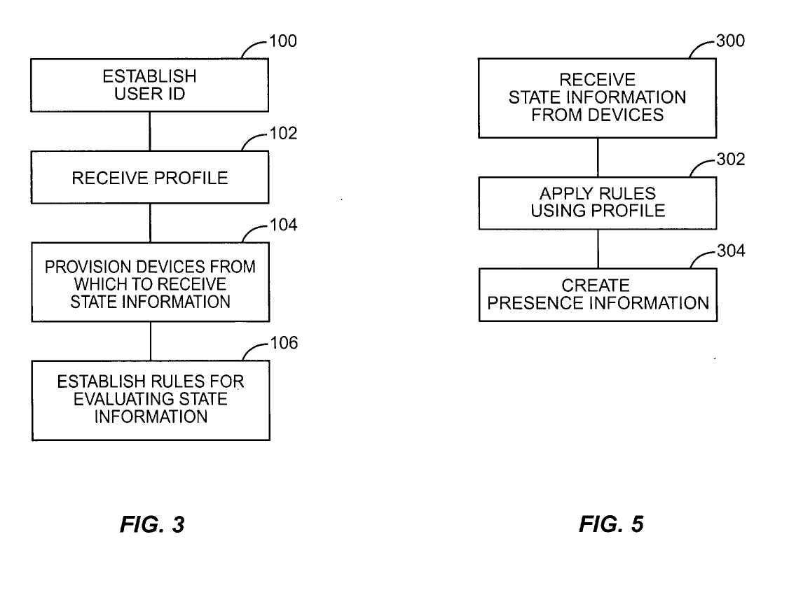

An exemplary process for initializing the presence system 20 to disseminate presence information is outlined in FIG. 3. Initially, the subscriber must establish an identification for the presence system 20 (step 100). The presence system 20 will then receive a profile for the subscriber (step 102). Based on the profile, the presence system 20 is provisioned to receive state information from the devices (sources) associated with the individual (step 104). Preferably, the device management logic 60 is configured to receive the state information from the provisioned devices. To configure the devices, individuals associated therewith may have to interact directly with the devices, or some server or switch attached thereto, in order to configure the devices to start sending status information to a certain entity associated with the presence system 20 or directly to the presence system 20. An exemplary model may be for the devices to essentially subscribe to supply information on behalf of an individual, who will essentially authorize the devices to provide the status information. Next, the rules for evaluating the state information for the various individuals are established based on the subscriber's profile (step 106). At this point, the rules management logic 58 and device management logic 60 are configured for a given user.

The rules typically define how to evaluate the state information associated with the individuals and deliver the resultant presence information to a subscriber. The subscriber may use the profile to establish rules to control how they should be contacted based on the state of one or more devices of the individuals being monitored. For example, the following hierarchy may be implemented:

if the individual's office PC is in use and the office telephone is on-hook, send presence information indicating the individual is available in the office and directing subscribing presence applications to contact the individual for voice conversations using an office telephone;

if the individual's office PC is in use and the office telephone is off-hook, send presence information indicating the individual is in the office but unavailable for voice conversations and directing subscribing presence applications to contact the individual via instant message or office email;

if the individual's mobile telephone is on and in a meeting mode, send presence information indicating the individual is in a meeting and not readily available and directing subscribing applications to contact the individual via a pager if urgent, otherwise via email;

if the individual's office PC is off and the individual's mobile telephone is on and not engaged in a call, send presence information indicating the user is out of the office but available if necessary and directing subscribing applications to contact the individual via the mobile telephone;

if the individual is driving a vehicle (telemetry), send presence information indicating the individual is in transit and directing subscribing applications to contact the individual via the mobile telephone; and

if the individual is interacting with an internet appliance or home entertainment system, send presence information indicating the individual is at home and directing subscribing applications to contact the user via the individual's home telephone.

Alternatively, the presence information may simply estimate the individual's availability and potentially a location rather than providing the level of granularity illustrated above, and allow the subscriber to choose how to process the information and contact the individual, if desired.

Those skilled in the art will recognize limitless variations in profile and rule constructions for evaluating state information and generating presence information to send to subscribing presence applications 24. Further, any combination of current and past device state information may be used to determine the presence information. Preferably, the presence information is automatically updated, if necessary, when state changes are detected. Depending on the presence rules, a state change from a given device may or may not impact the presence information. If the presence information does not change, then there may not be a need to update the subscribing presence applications 24.

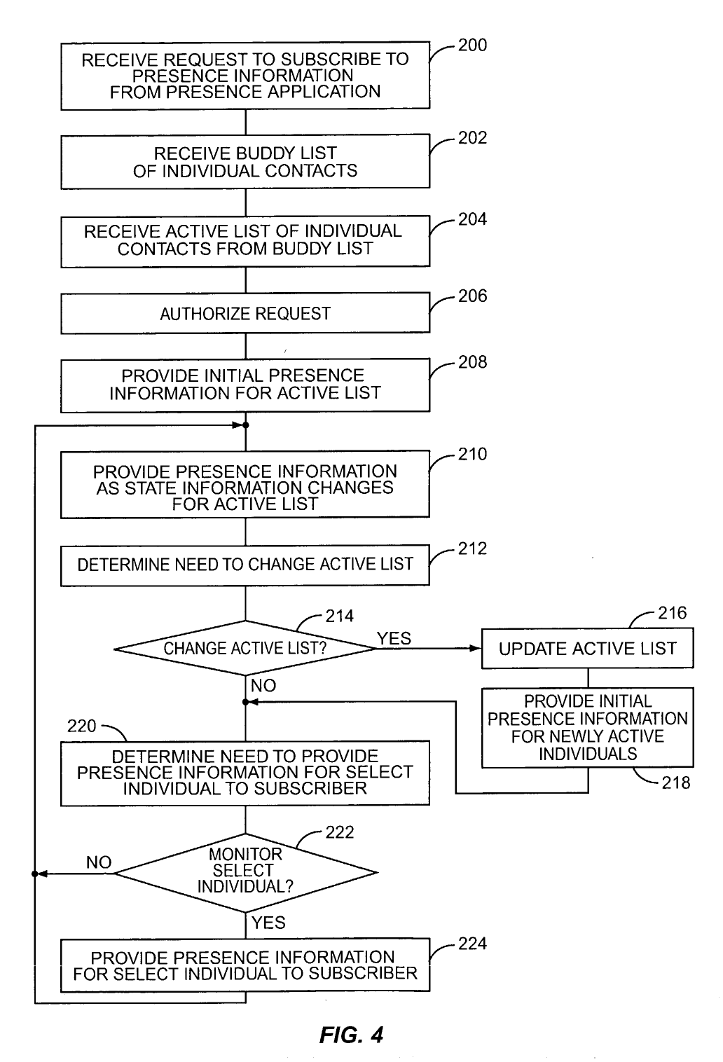

FIG. 4 provides an exemplary process for subscribing to and delivering presence information to a subscriber through the presence system 20 according to one embodiment of the present invention. Initially, a subscriber, via their associated presence application 24, will send a request to subscribe to the presence system 20. The subscription management logic 56 of the presence system 20 will receive the request for presence information from the presence application 24 (step 200). Preferably, the presence system 20 will also receive a buddy list of individual contacts (step 202), and an active list of individual contacts from the buddy list (step 204) from the presence system 20. Notably, the buddy and active lists may be created over time and updated periodically. Based on the request, the presence service 20 will authorize the request (step 206) and, if authorized, provide initial presence information for the individuals in the active list to the subscribing presence application 24 (step 208). The initial presence information may be default presence information or that based on current states of the devices, which are associated with the respective individuals, as evaluated by the rules. Once subscribed, the presence system 20 will provide presence information to the presence application 24 as state information causes the presence information to change for the various individuals in a manner warranting a presence update (step 210). On an ongoing basis, the presence system 20 will determine a need to change the active list based on user input relayed to the presence system 20 from the presence application 24, external events, or predefined criteria (step 212). Notably, presence information is provided only for those in the active list.

The active list of individuals for which presence information is desired may be controlled with an active list profile, which defines criteria for adding individuals to the active list, subtracting individuals from the active list, or completely changing those individuals in the active list at any given time. For example, individuals in the active list may be changed based on time or date, an external event, the availability or presence of the subscriber, or other preconfigured data. For example, the active list may contain individuals associated with work and immediate family members during business hours throughout a workweek, wherein the active list may include friends and extended family members in addition to immediate family members in the evenings and during weekends. Further, any type of event, such as a weather or news alert, or a change in state of a monitored device, may trigger a change in the active list. The active list may also be controlled by the type and availability of the individuals for communication. For example, the active list may include only those individuals capable of communication via a select medium. In one instance, the active list would only include those available to communicate via telephone or email. If a change in the active list is warranted (step 214), the active list is updated (step 216) and initial presence information for the newly active individual is provided to the presence application 24 (step 218).

In addition to dynamically changing the individuals associated with the active list, the subscriber may dynamically trigger retrieval of information for individuals not in the active list. In one embodiment, the presence application 24 will send a message to the presence system 20 to provide presence information for a select individual not on the active list. In association with this request, information may be provided relating to how long presence information for the selected individual should be monitored. The extent of the time period may range from simply providing presence information for the select individual once in an instantaneous fashion to continuously monitoring the presence information for a select period of time. The period may be a default period of time, or may be custom set in the request. Alternatively, monitoring may continue until the presence system 20 is instructed not to provide presence information for the selected individual. Those skilled in the art will recognize various ways to control the amount of presence information and the length of the period for which presence information is monitored. For example, presence information for the selected individual may be provided until the subscriber and the individual participate in a successful communication. As such, some mechanism must be in place wherein the presence system 20 can automatically receive such information.

Thus, the presence system 20 will periodically determine the need to provide presence information for a select individual to a subscriber via the presence application 24 (step 220). The determination may be receiving the request as well as updating information pursuant to a previous request. Once a need has been established to provide presence information for a select individual (step 222), the presence application 20 will monitor the state information and the like for the select individual and provide presence information for the select individual to the subscriber (step 224).

Alternatively, the presence application 24 may control the contact or buddy list as well as the active list. Once the active list is created or modified, the presence application 24 can simply subscribe to the presence system 20 to receive presence information for the individuals on the active list. If an individual outside of the active list needs to be monitored, the user can simply select the appropriate contact to trigger the presence application 24 to subscribe to the presence system 20 for presence information for the selected individual. The latter subscription may be separate from that of the active list or configured to cancel a previous subscription and include the active list and selected individuals. The subscription for the selected individual outside of the active list may identify how long the presence information should be delivered to the subscriber's hardware running the presence application.

When the presence application 24 sends requests to subscribe or unsubscribe to the presence system 20, the presence system 20 is unaware of the complications of active subsets or any real details on buddy lists. This latter alternative minimizes the processing required in the presence system 20 and distributes processing to the presence application 24.

In essence, presence information is delivered only for those individuals in a particular subscriber's active list. The subscriber can simply click on an individual having an inactive status, and on demand be provided their current status along with an opportunity to designate a time period for which to monitor the presence information of the individual. The time period can be established from a default, or may be specified as part of the request for active monitoring.

In one embodiment of the present invention, an on-demand presence query may be configured such that additional presence information is provided to the subscriber via the presence application 24. The additional information may provide greater detail relating to the best manner in which to contact the individual, the location of the individual, or other characteristics of the individual. In an effort to minimize network traffic and processing resources required to implement the presence system 20, an on-demand query would generally provide more presence information than the normal presence information provided for those individuals in the active list, if so desired.

FIG. 5 illustrates an exemplary process for evaluating state information from the provisioned devices. The process continuously receives state information from all provisioned devices associated with all individuals being monitored for each subscriber's presence application 24 (step 300) and applies the rules for generating presence information based on each subscriber's profile (step 302). Notably, the presence application 24 or subscriber associated therewith can also provide a profile to configure or otherwise filter the types of presence information requested. Finally, the rules management logic 58 will evaluate the state changes and create presence information, if necessary, to send to the subscribing presence applications 24 (step 304).

Accordingly, state information from natural human interactions with devices are received and evaluated by a rules-based presence system 20 that takes into account relatively static preferences supplied directly by the individual wishing to project an indication of presence along with optional positional data associated with the devices. Those skilled in the art will recognize that manually provided state information may be used by the rules logic management 58 in combination with those initiated from naturally occurring interactions.

In an effort to further control delivery of the presence information, subscribers identify select individuals from a contact list to place in an active list. In normal operation, presence information is only received for those individuals appearing on a subscriber's active list. A subscriber can dynamically request presence information for individuals who are not on the active list by simply selecting the individual or clicking an icon associated with the individual in traditional fashion. Preferably, the presence application 24 provides a graphical user interface with icons associated with individuals to be monitored. Those individuals on the active list are differentiated from those not on the list. Further, upon selecting an inactive individual, the presence application 24 will associate a time to continue monitoring the selected individual automatically using a default period or query the subscriber to provide a time to monitor. As noted above, selection of the inactive individual may be configured to provide a one-time, instantaneous presence view. Alternatively, the monitoring may continue until an event occurs, such as establishment of a communication or media session between the selected individual and the subscriber.

In one embodiment, less detailed presence information is provided during normal monitoring of individuals on the active list and more detailed presence information is provided upon selecting an individual who is or is not on the active list. In any of these embodiments, the presence application 24 may be configured to allow the subscriber to readily move individuals to and from the active list and control the amount of presence information delivered and how it is displayed to maximize the usefulness of the information.

Although many communication protocols may be used to facilitate communications, including delivery of state and presence information between the various devices, the Session Initiation Protocol (SIP) or the SIP for Instant Messaging and Presence Leveraging Extensions (SIMPLE) protocol is implemented in one embodiment of the present invention. The specification for SIP is provided in the Internet Engineering Task Force's RFC 2543: Session Initiation Protocol Internet Draft, which is incorporated herein by reference in its entirety.

In general, a SIP proxy, such as may be provided by the proxy server 28, may facilitate media sessions between any number of endpoints, which represent devices communicating with each other. These endpoints may support any one or combination of data, audio, and voice media sessions, depending on the configuration of the respective endpoints. In addition to traditional SIP endpoints, endpoints for the present invention may take the form of the switch 14, the registrar 26, the presence system 20, the device running the presence application 24, and the like.

A SIP endpoint is generally capable of running an application, which is generally referred to as a user agent (UA), and is capable of facilitating media sessions using SIP. User agents register their ability to establish sessions with a SIP proxy, such as proxy server 28, by sending “REGISTER” messages to the SIP proxy. The REGISTER message informs the SIP proxy of the SIP universal resource locator (URL) that identifies the user agent to the SIP network. The REGISTER message also contains information about how to reach specific user agents over the SIP network, by providing the Internet Protocol (IP) address and port that the user agent will use for SIP sessions.

A “SUBSCRIBE” message may be used to subscribe to an application or service provided by a SIP endpoint. Further, “NOTIFY” messages may be used to provide information between SIP endpoints in response to various actions or messages, including REGISTER and SUBSCRIBE messages.

When a user agent wants to establish a session with another user agent, the user agent initiating the session will send an INVITE message to the SIP proxy and specify the targeted user agent in the TO header of the INVITE message. Identification of the user agent takes the form of a SIP URL. In its simplest form, the URL is represented by a number or “<username>@<domain>,” such as “janedoe@nortelnetworks.com.” The SIP proxy will use the SIP URL in the TO header of the message to determine if the targeted user agent is registered with the SIP proxy. Generally, the user name is unique within the name space of the specified domain.

If the targeted user agent has registered with the SIP proxy, the SIP proxy will forward the INVITE message directly to the targeted user agent. The targeted user agent will respond with a 200 OK message, and a session between the respective user agents will be established as per the message exchange required in the SIP specification. Media capabilities are passed between the two user agents of the respective endpoints as parameters embedded within the session setup messages, such as the INVITE, 200 OK, and acknowledgement (ACK) messages. The media capabilities are typically described using the Session Description Protocol (SDP). Once respective endpoints are in an active session with each other and have determined each other's capabilities, the specified media content may be exchanged during an appropriate media session.

The following example illustrates detailed message flows related to telephony devices, which are in one particular class of devices that can provide state information. Other classes of devices, including but not limited to those previously discussed, may have their own unique message flows to achieve similar results. Those skilled in the art will recognize there are many implementation methods possible for associating devices with the presence system 20. This SIP-based example provides a relatively simple way to describe relevant message flows.

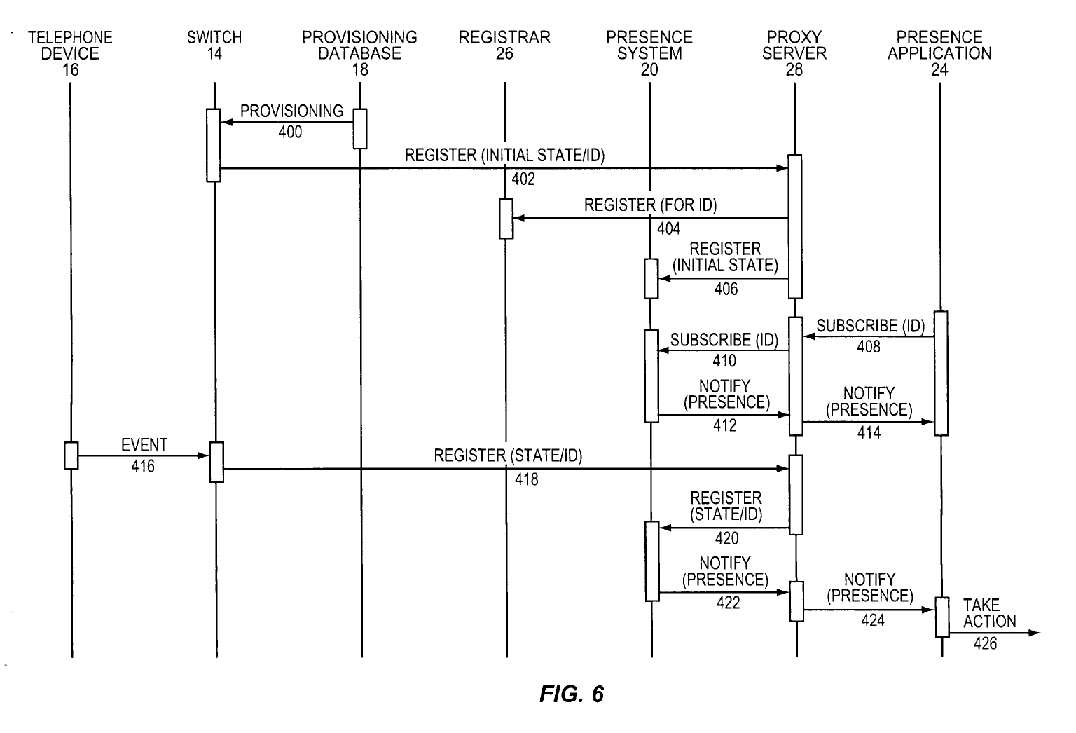

An exemplary message flow for providing state information relating to a telephony device 16 on the circuit-switched network 10 is illustrated in FIG. 6. Although the SIP protocol is used for illustration, those skilled in the art will recognize the general functionality of the described messages and their applicability to other protocols. Further, the switch 14 is preferably configured to monitor states resulting from naturally occurring user interactions and provide corresponding state information to the presence system 20. For example, the natural interaction could be the individual selecting a mode of operation, such as ring or meeting (off or vibrate), or actually participating in a call.

The flow begins when an individual initially requests activation of the telephony device 16 through a local exchange carrier or like entity, which controls access and communications for the telephony device 16. Typically, the telephony device 16 is provisioned by providing provisioning information from the provisioning database 18 to the switch 14 (step 400). The traditional provisioning information is supplemented with information indicating whether the user of telephony device 16 wishes to subscribe to the presence service provided by the presence system 20. Accordingly, the switch 14 will receive the provisioning information from the provisioning database 18 and provision the telephony device 16, as well as store information that correlates the relationship between the telephony device 16 and a presence ID, which is used by the presence system 20 for determining the state of the telephony device 16. The telephony device 16 is typically identified on the circuit-switched network 10 using a directory number, caller identification, or similar designation. Alternatively, an individual may be able to dynamically provision a device using the device itself, without requiring the network operator to take action.

Once the provisioning of the telephony device 16 is complete, the switch 14 will send a REGISTER message to the proxy server 28 (step 402). Preferably, the switch 14 registers as a user agent, and the proxy server 28 acts as a SIP proxy server. The REGISTER message effectively registers the ability of the switch 14 to provide presence information with the SIP proxy 28. In particular, the REGISTER message informs the proxy server 28 of the SIP URL that identifies the user agent of the switch 14 to the (SIP) packet-switched network 12. The REGISTER message may also contain information about how to reach the user agent over the packet-switched network 12, typically by providing the Internet Protocol (IP) address and port that the user agent will use for SIP sessions. Preferably, the REGISTER message will also include an initial state of the telephony device 16 and identification indicia for the telephony device 16. The identification indicia in a SIP environment is preferably a SIP ID, which is the logical address associated with the telephony device 16 as represented on the packet-switched network 12.

In response to this initial REGISTER message, the proxy server 28 will send a like REGISTER message to the registrar 26 to register the telephony device 16 with the registrar 26 (step 404). Further, the proxy server 28 may also forward the REGISTER message to the presence system 20 (step 406). At this point, the presence system 20 has registered the telephony device 16 and has associated an initial state for the telephony device 16. All other devices used to determine presence information of an individual will register in the same or similar fashion.

The presence system 20 consolidates and/or transforms device data into the state associated with a logical or user identification and provides relevant state information to the presence application 24. Subsequently, the presence application 24 will subscribe to the presence service provided by the presence system 20 to receive presence state information based on state changes associated the various devices of the user. Accordingly, the presence application 24 will send a SUBSCRIBE message, which includes identification information (SIP ID) of the individual or telephony device 16, to the proxy server 28 (step 408), which will forward the SUBSCRIBE message to the presence system 20 (step 410). In response, the presence system 20 will use the SIP ID provided in the SUBSCRIBE message to identify the individual or devices for which presence information is requested. Once the presence system 20 has evaluated the state of the telephony device 16, a NOTIFY message, including presence information for the individual associated with the telephony device 16, is sent to the proxy server 28 (step 412), which forwards the NOTIFY message to the presence application 24 (step 414). At this point, the presence application 24 has subscribed to the presence service 20 for the individual and has received the initial presence information for the individual, and perhaps the state of the telephony device 16 and other devices, if so provisioned. Thus, the presence application 24 may react as necessary in response to receiving the presence information for the individual and awaits state change notifications associated with the individual.

Assume that the telephony device 16 changes state, such as being placed on-hook, going off-hook, initiating a hold function, going out of service, initiating a service activation, changing modes, or the like. In essence, any change of state caused by a naturally occurring transition will trigger an event, which is sent to the switch 14 in traditional fashion (step 416). In addition to normal processing of the event, the switch 14 will recognize that the telephony device 16 has been provisioned to alert the presence service of state changes, and will send a REGISTER message identifying the telephony device 16 (preferably using the SIP ID) and including the current state to the proxy server 28 (step 418), which represents the presence system 20 to the switch 14. The proxy server 28 will then send a REGISTER message to register the new state in association with the identified telephony device 16 with the presence system 20 (step 420). The presence system 20 will then process the state information to create the presence information for the user and send a NOTIFY message, if necessary, to the proxy server 28 to provide the updated presence information (step 422). The proxy server 28 will forward the NOTIFY message, which includes the presence information, to the presence application 24 (step 424), which can then take appropriate action based on the state information (step 426). As noted above, the state information may be associated with location information in an appropriately configured wireless communication system.

Those skilled in the art will recognize that the use of REGISTER messages is only one implementation. In general, the switch 14 or some other device that provides autonomous state change information can use a REGISTER message or some other undefined message to notify the presence service. If the presence system 20 subscribes to the information on the switch 14, which changes the role of the switch 14 to that of a presence user agent, it would allow the use of NOTIFY messages to communicate the presence data to the presence system 20.

The switch 14 may be configured to provide a table, which correlates the identification of the telephony device 16 on the circuit-switched network 10 with a presence identity, which is preferably a SIP address or URL. Using this table, the switch 14 can identify state changes for the telephony device 16, process the changes based on the rules management logic 58, and send updated state information indirectly or directly to the presence system 20. For example, assume that an individual has subscribed to an automatic presence service from a cellular communication operator. Part of the service subscription process will provision a presence address and correlate it with a registered mobile telephone 16B, based either upon the mobile identification number, a SIM card identification, the telephone number, or like designation.

Whenever the individual's mobile telephone 16B is on and in reach of the mobile network, the home location register (HLR) is made aware of this fact as part of the normal course of cellular telephone operation. The HLR can register on-line status on behalf of the individual's presence identification based on this information. As noted, the state information may include location identification in addition to traditional state information. Those skilled in the art will recognize the application of the present invention to both traditional time division multiplexing (TDM) switching systems and more recent innovations, such as IP public branch exchanges, or telephony clients, such as SIP user agents, H.323 endpoints, Microsoft NetMeeting, or real-time communication clients. Network resources, such as SIP proxies or H.323 gatekeepers, may also apply this technology if they retain call status information on the endpoints or user agents they manage.

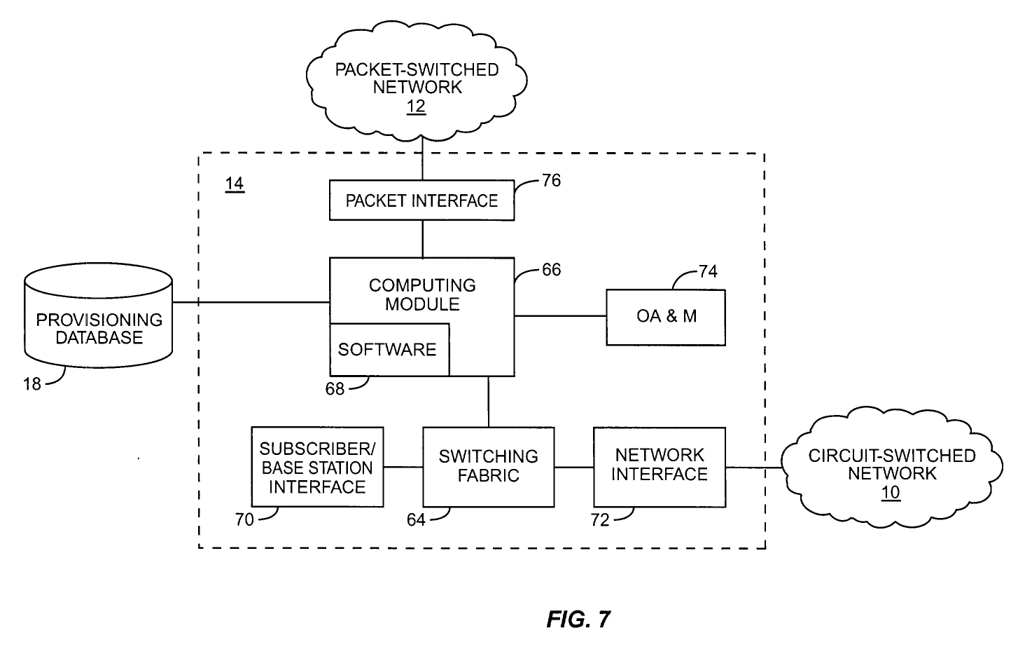

Turning now to FIG. 7, a block representation of a switch 14 is illustrated. The switch 14 is represented generically and is intended to cover the logical functionality of land-based and mobile switching systems, which include all control for call server-based functions. These switches may be implemented in a variety of ways using different equipment types, such as Nortel Networks Limited's DMS-100 local switching system. The switch 14 typically includes a switching fabric module 64, a computing module 66 including storage software 68, a subscriber/base station interface 70, a network interface 72, an operations/administration and maintenance (OA & M) module 74 and a packet interface 76. The switching fabric 64 may comprise logical and physical switches for interconnecting the subscriber/base station interface 70 with the remainder of the circuit-switched network 10 through the network interface 72. Depending on a land-based or wireless embodiment, the subscriber/base station interface 70 will either directly support subscribers through subscriber lines or will support base stations, which facilitate wireless communications with mobile devices. As illustrated, the computing module 66 controls circuit-switched communications via the switching fabric 64 and is capable of providing traditional intelligent network monitoring and functions. Further, the computing module 66 may cooperate with the provisioning database 18 as described above. As noted above, the functionality of the switch 14 may be provided in various levels of integration.

In operation, the software 68 of the computing module 66 is modified to recognize state changes associated with supported telephony devices 16 and to provide the state information via the packet interface 76 either directly or indirectly to the presence system 20 on the packet-switched network 12. As noted, the messages sent to the presence system 20 will include identification of the associated telephony device 16, relative state information, and perhaps location information derived from a mobile telephone 16B or from elsewhere in the system. Preferably, the computing module 66 will cooperate with the provisioning database 18 to store information indicating that the particular telephony device 16 is subscribing to the presence service and providing an address for sending state change messages directly or indirectly to the presence system 20. The other devices providing state information are similarly configured to trigger delivery of state information upon recognizing the occurrence of an event caused by the natural interaction with the device.

Current presence technology standards and systems are provided for in references from the Internet Engineering Task Force (IETF). Presence technology protocol-related publications hereby incorporated by reference include: Day, M., Aggarwal, S. and Vincent, J., “Instant Messaging/Presence Protocol Requirements,” Request for Comment (RFC) 2779, February 2000; Day, M., Rosenberg, J. and Sugano, H., “A Model for Presence and Instant Messaging,” RFC 2778, February 2000; Rosenberg, J. and Schulzrinne, H., “SIP caller preferences and callee capabilities,” (work in progress), November 2000; Crocker, D. et al., “A Common Profile for Instant Messaging (CPIM),” (work in progress), February 2001. Further information pertaining to delivery and control of presence information may be found in the following commonly owned, U.S. patent applications, which are incorporated herein by reference in their entirety: U.S. patent application Ser. No. 10/100,703 filed Mar. 19, 2002, U.S. patent application Ser. No. 10/101,286 filed Mar. 19, 2002, U.S. patent application Ser. No. 10/119,923 filed Apr. 10, 2002, and U.S. patent application Ser. No. 10/119,783 filed Apr. 10, 2002.

Those skilled in the art will recognize improvements and modifications to the preferred embodiments of the present invention. All such improvements and modifications are considered within the scope of the concepts disclosed herein and the claims that follow.

What is claimed is:

1. A method for providing presence information comprising:
a) creating a buddy list of individuals whose presence information is available for a subscriber;
b) creating an active list of the individuals from the buddy list;
c) requesting presence information from a presence system for the individuals on the active list; and
d) receiving the presence information from the presence system.

2. The method of claim 1 wherein only the presence information for the individuals on the active list are requested by the presence application.

3. The method of claim 1 further comprising dynamically adding an individual from the buddy list to the active list.

4. The method of claim 1 further comprising dynamically removing an individual from the active list to the buddy list.

5. The method of claim 1 further comprising changing the individuals associated with the active list based on defined criteria.

6. The method of claim 5 wherein the defined criteria comprises time or date criteria such that a composition of the active list changes based on the time or date criteria.

7. The method of claim 5 wherein the defined criteria comprises an occurrence of an event such that a composition of the active list changes upon occurrence of the event.

8. The method of claim 5 wherein the defined criteria comprises subscriber presence criteria such that a composition of the active list changes based on the presence or availability of the subscriber.

9. The method of claim 1 further comprising:
a) sending a request to the presence system to receive the presence information for a select individual not on the active list; and
b) receiving the select presence information from the presence system.

10. The method of claim 9 wherein the select presence information is delivered once in response to the request to receive the presence information for the select individual.

11. The method of claim 9 wherein the select presence information is delivered as necessary over a defined period of time.

12. The method of claim 11 wherein the period of time is set by the subscriber in association with the request to receive the presence information for the select individual.

13. The method of claim 9 wherein the select presence information is received until a communication is established between devices associated with the select individual and the subscriber.

14. The method of claim 9 wherein the select presence information is received as necessary until the presence application sends a message to stop providing the select presence information.

15. The method of claim 9 wherein the select presence information includes information in addition to the presence information for the individuals on the active list.

16. A system for providing presence information comprising a control system adapted to:
a) create a buddy list of individuals whose presence information is available for a subscriber;
b) create an active list of the individuals from the buddy list;
c) request presence information from a presence system for the individuals on the active list; and
d) receive the presence information from the presence system.

17. The system of claim 16 wherein only the presence information for the individuals on the active list are requested by the presence application.

18. The system of claim 16 wherein the control system is further adapted to dynamically add an individual from the buddy list to the active list.

19. The system of claim 16 wherein the control system is further adapted to dynamically remove an individual from the active list to the buddy list.

20. The system of claim 16 wherein the control system is further adapted to dynamically change the individuals associated with the active list based on defined criteria.

21. The system of claim 20 wherein the defined criteria comprises time or date criteria such that a composition of the active list changes based on the time or date criteria.

22. The system of claim 20 wherein the defined criteria comprises an occurrence of an event such that a composition of the active list changes upon occurrence of the event.

23. The system of claim 20 wherein the defined criteria comprises subscriber presence criteria such that a composition of the active list changes based on the presence or availability of the subscriber.

24. The system of claim 16 wherein the control system is further adapted to:
a) send a request to the presence system to receive the presence information for a select individual not on the active list; and
b) receive the select presence information from the presence system.

25. The system of claim 24 wherein the select presence information is received once in response to the request to receive the presence information for the select individual.

26. The system of claim 24 wherein the select presence information is received as necessary over a defined period of time.

27. The system of claim 26 wherein the period of time is set by the subscriber in association with the request to receive the presence information for the select individual.

28. The system of claim 24 wherein the select presence information is received until a communication is established between devices associated with the select individual and the subscriber.

29. The system of claim 24 wherein the select presence information is received as necessary until the presence application sends a message to stop providing the select presence information.

30. The system of claim 24 wherein the select presence information includes information in addition to the presence information for the individuals on the active list.

31. A computer readable medium comprising instructions for instructing a computer to:
a) create a buddy list of individuals whose presence information is available for a subscriber;
b) create an active list of the individuals from the buddy list;
c) request presence information from a presence system for the individuals on the active list; and
d) receive the presence information from the presence system.

32. A method for providing presence information comprising:
a) providing a buddy list of individuals whose presence information is available for a subscriber;
b) creating an active list of the individuals from the buddy list;
c) receiving state information from devices associated with the individuals on the active list;
d) evaluating the state information to create the presence information for the individuals; and
e) sending the presence information to a presence application associated with the subscriber.

33. The method of claim 32 wherein only the presence information for the individuals on the active list are provided to the presence application.

34. The method of claim 32 further comprising dynamically adding an individual from the buddy list to the active list.

35. The method of claim 32 further comprising dynamically removing an individual from the active list to the buddy list.

36. The method of claim 32 further comprising changing the individuals associated with the active list based on defined criteria.

37. The method of claim 36 wherein the defined criteria comprises time or date criteria such that a composition of the active list changes based on the time or date criteria.

38. The method of claim 36 wherein the defined criteria comprises an occurrence of an event such that a composition of the active list changes upon occurrence of the event.

39. The method of claim 36 wherein the defined criteria comprises subscriber presence criteria such that a composition of the active list changes based on the presence or availability of the subscriber.

40. The method of claim 32 further comprising:
a) receiving a request to receive the presence information for a select individual not on the active list via the presence application;
b) evaluating the state information for the select individual to create select presence information for the select individual; and
c) sending the select presence information to the presence application associated with the subscriber.

41. The method of claim 40 wherein the select presence information is delivered once in response to the request to receive the presence information for the select individual.

42. The method of claim 40 wherein the select presence information is delivered to the presence application as necessary over a defined period of time.

43. The method of claim 42 wherein the period of time is set by the subscriber in association with the request to receive the presence information for the select individual.

44. The method of claim 40 wherein the select presence information is delivered to the presence application until a communication is established between devices associated with the select individual and the subscriber.

45. The method of claim 40 wherein the select presence information is delivered to the presence application as necessary until the presence application sends a message to stop providing the select presence information.

46. The method of claim 40 wherein the select presence information includes information in addition to the presence information for the individuals on the active list.

47. A system for providing presence information comprising a control system adapted to:
a) provide a buddy list of individuals whose presence information is available for a subscriber;
b) create an active list of the individuals from the buddy list;
c) receive state information from devices associated with the individuals on the active list;
d) evaluate the state information to create the presence information for the individuals; and
e) send the presence information to a presence application associated with the subscriber.

48. A computer readable medium comprising instructions for instructing a computer to:
a) provide a buddy list of individuals whose presence information is available for a subscriber;
b) create an active list of the individuals from the buddy list;
c) receive state information from devices associated with the individuals on the active list;
d) evaluate the state information to create the presence information for the individuals; and
e) send the presence information to a presence application associated with the subscriber.
